(19) United States
(12) Patent Application Publication
(10) Pub. No.: US 2013/0329845 A1
(43) Pub. Date: Dec. 12, 2013

(54) SYSTEMS, APPARATUSES AND METHODS FOR THE IMPLEMENTATION OF AN ENERGY SYSTEM

(71) Applicant: Edward L. Davis, Tigard, OR (US)

(72) Inventor: Edward L. Davis, Tigard, OR (US)

(73) Assignee: INTELLIGENT POWER CORP, Portland, OR (US)

(21) Appl. No.: 13/823,475

(22) PCT Filed: Sep. 16, 2011
(86) PCT No.: PCT/US2011/051986

§ 371 Date: Mar. 14, 2013

Related U.S. Application Data
(60) Provisional application No. 61/383,330, filed on Sep. 16, 2010.

(51) Int. Cl. G21B 1/00; G21B 1/19

(52) U.S. Cl. CPC G21B 1/00; G21B 1/19
USPC 376/146; 376/151

(57) ABSTRACT

In accordance with embodiments disclosed herein, there are provided systems, apparatuses and methods for the implementation of an energy system. A mechanical fusion energy system using uniquely constructed fuel pellets containing a variety of fusion capable materials to achieve up to many Megawatts of relatively continuous power output. The disclosed energy system utilizes a quantum approach of individual discrete pops periodically as needed to maintain a fairly continuous flow of energy. It may generate several thousand KWhr of energy per pop and dependent on the pop rate may generate well over 1,000 Megawatts, equivalent to the largest power generating stations currently in operation.

### CLAIM OF PRIORITY

This application is related to, and claims priority to, the U.S. provisional utility application entitled “ULTIMATE ENERGY SYSTEM METHODS AND APPARATUS,” filed on Sep. 16, 2010, having application No. 61/383,330.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments relate generally to the field of computing, and more particularly, to systems, apparatuses and methods for the implementation of an energy system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to disclosed embodiments.

Embodiments of the present invention relate generally to Energy Generation Systems, and in particular, systems, methods, and apparatuses for implementing a Nuclear Fusion Reactor which operates in standalone mode or implemented in an overall Energy Generation and transmission system.

Conventional energy generation systems in use today are not based upon fusion energy.

Although, there is no specific prior art that has been successful in mechanical fusion energy generation, there have been major strides in diverse materials and technology areas leading up to this invention that lay the foundation to make it possible. Areas like sixteen inch guns, hydraulic presses that develop thousands of tons of force, high strength materials like Inconel™ (e.g., a commercial provider of special metals and alloys), titanium, and top fuel dragster engines that develop several thousand horsepower and pressures of over 25,000 psi at 10,000 times per minute.

The present state of the art may therefore benefit from systems, methods, devices, and apparatuses for implementing a mechanical fusion energy generation system as described herein.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1 depicts a fusion engine overview system, showing a fusion engine, blowdown vessel, and a high pressure regulator along with representative balance of plant elements in accordance with which embodiments may operate;

FIG. 2 depicts a 3D view of an exemplary 16.0 ft diameter by 10.0 ft. high forged titanium or steel pressure vessel for 2500 psi operation in accordance a disclosed embodiment;

FIG. 3 depicts an exemplary cutaway view of pressure vessel showing half of a Toroid in accordance with which embodiments may operate;

FIG. 4 depicts an exemplary cutaway view of lower half of pressure vessel showing a water inlet in accordance with which embodiments may operate;

FIG. 5 depicts an exemplary energy system core assembly front view in accordance with disclosed embodiments;

FIG. 6 depicts an exemplary energy system cutaway overview in accordance with disclosed embodiments;

FIG. 7 depicts an exemplary energy system core assembly rear view showing a robot access door in accordance with disclosed embodiments;

FIG. 8 depicts two views of fuel pellet cap assemblies in accordance with disclosed embodiments;

FIG. 9 depicts a sub-assembly containing the Pressure Chamber, upper hydraulic actuated pile driver and lower hydraulic actuated pile driver/receiver in accordance with disclosed embodiments; and

FIG. 10 depicts a top assembly incorporating the sub-assembly of FIG. 9 and excluding the standard off-the-shelf water pump, blow down pressure vessel and high pressure regulator in accordance with the disclosed embodiments.

### DETAILED DESCRIPTION

Described herein are systems, apparatuses and methods for the implementation of an energy system. The history of nuclear fusion research has taken many turns since the “Hydrogen Bomb” which consisted basically of a fusion core with a fission sphere wrapped around it to compress and heat the core sufficiently to achieve Lawson's criterion to cause fusion. This is like a spherical shaped charge floating in space.

There have been many attempts to generate and contain fusion reactions like Shiva and the Tokamak's. Even today people at MIT are working with the International Thermonuclear Experimental Reactor (ITER) team where they are still attempting elaborate schemes like Magneto Hydro Dynamics (MHD), magnetic fusion, electron and ion cyclotron heating, etc. such efforts are in an attempt at sustaining and containing the plasma core of the fusion reaction; akin to having a miniature Sun here on earth, as will be appreciated by those skilled in the art.

The present invention teaches an alternative mechanism, having a pulsed, quantum like method. Applicant's disclosed mechanism represents an improvement because there is no need to contain extremely high temperature plasmas. The pulsed quantum method taught herein creates brief successive flashes of energy, rather than attempting to contain a forty plus million degree core continuously.

A simpler “brute force” mechanical approach is disclosed. The successive pulse and mechanical brute force approach is more akin to a series of explosions of tiny hydrogen bombs rather than attempting to contain the energy and temperatures of a tiny Sun here on Earth. Plasma does not need to be contained in accordance with the disclosed embodiments. Rather, it is allowed to pop, then turn water into high pressure steam, and then it is routed through steam turbines in order to convert heat energy and mechanical energy into electrical energy. The process is then repeated as often as needed to generate a wide range of energy amounts, energy units, or energy quantities, on an as needed basis. The disclosed system may pop less at night than during daytime peak energy periods to account for a difference in demand.

Once an explosion from the aforementioned pulse or pop dies down and all the extractable energy is taken and converted by the system to usable electrical energy, another pellet is inserted (e.g., by a robotic arm or other conveyor means), and then the next explosion occurs, thus utilizing a cyclical methodology.

In the following description, numerous specific details are set forth such as examples of specific systems, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

In the figures, the various embodiments are identified and labeled as follows:

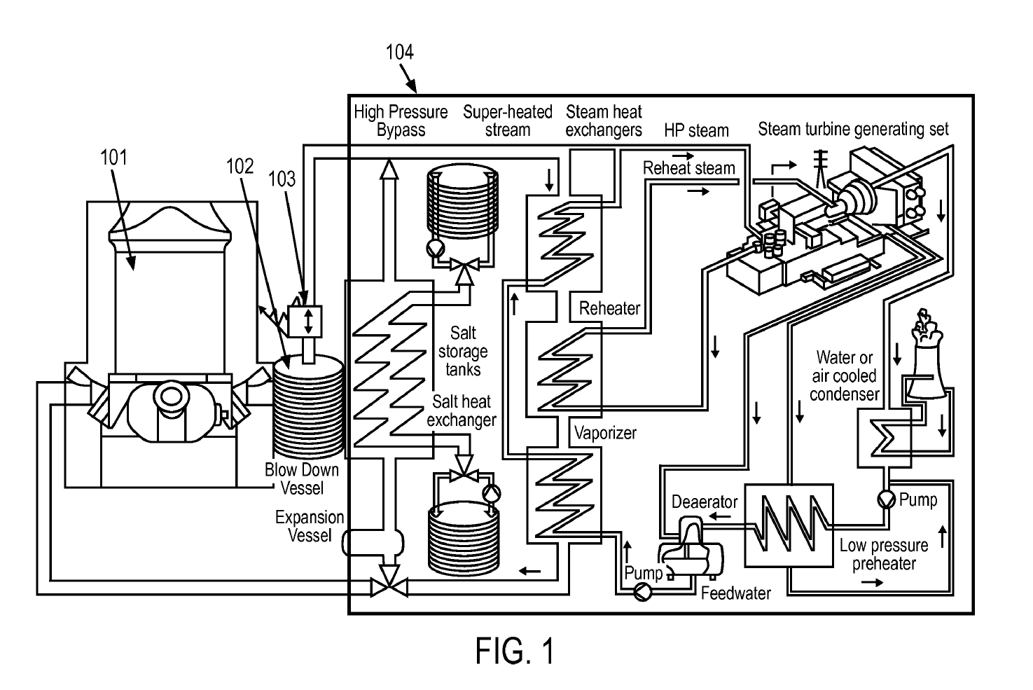

### FIG. 1 Elements:

element 101: a fusion engine;
element 102: a high pressure blowdown vessel;
element 103: a pressure regulator; and
element 104: an exemplary Balance of Plant (BoP) for illustrative purposes only.

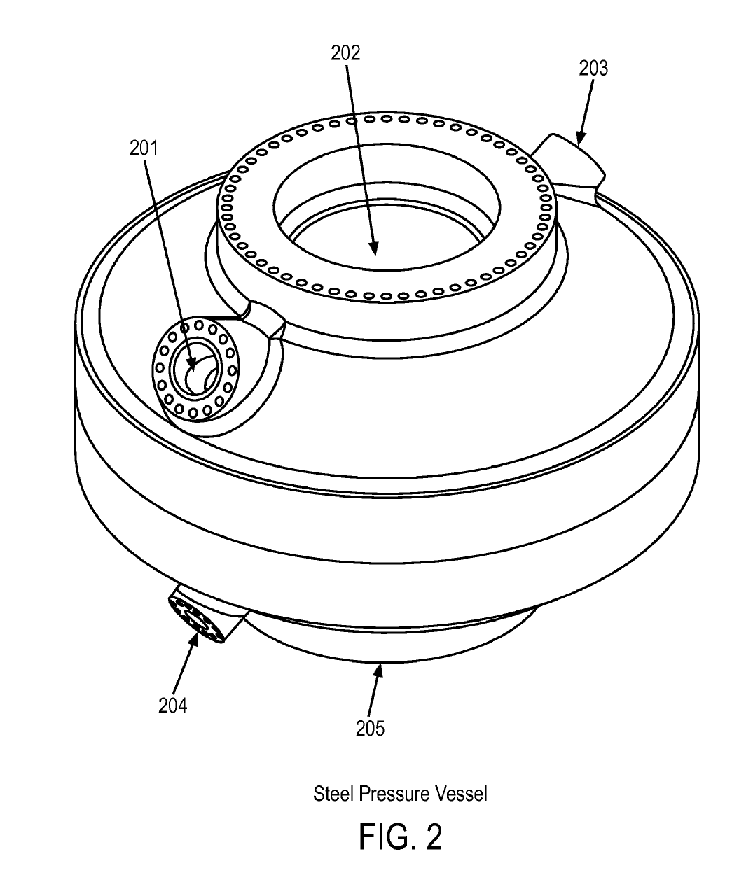

### FIG. 2 Elements:

element 201: a robot arm entry rotating door;
element 202: a pile driver entrance cavity;
element 203: a high pressure steam outlet;
element 204: a water inlet; and
element 205: a pile driver recoil spring cavity.

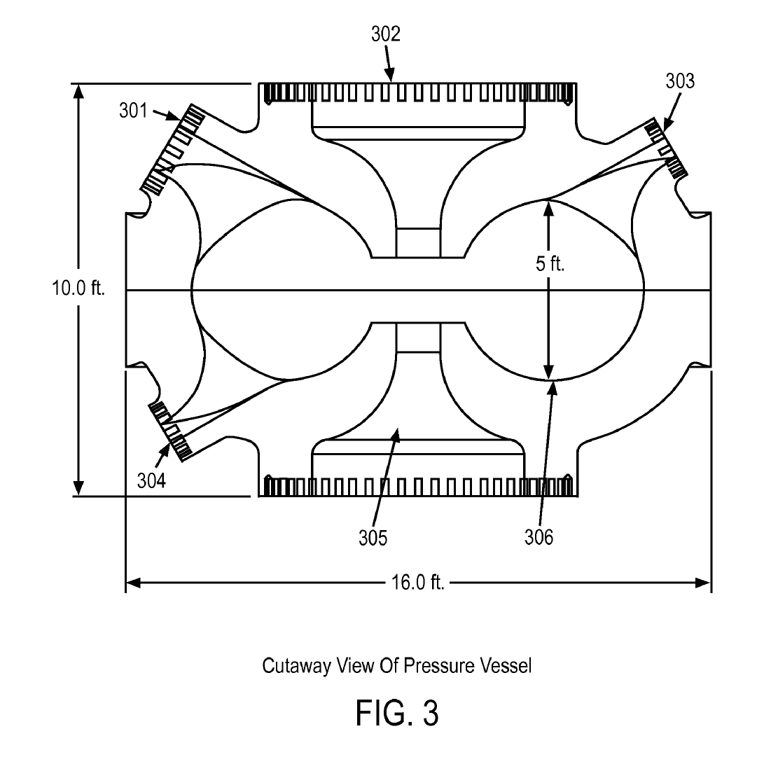

### FIG. 3 Elements:

element 301: a robot arm entry rotating door;
element 302: a pile driver entrance cavity;
element 303: a high pressure steam outlet;
element 304: a water inlet;
element 305: a pile driver recoil spring cavity; and
element 306: a large Toroid with the center cutout for containing the water and steam.

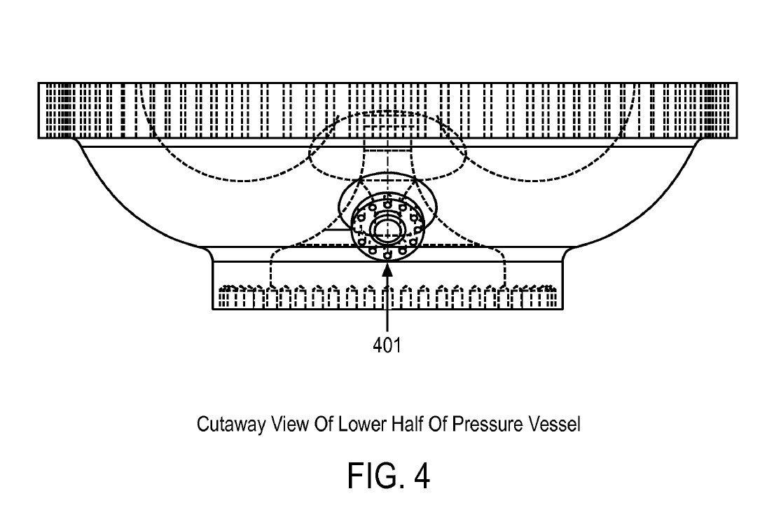

### FIG. 4 Elements:

element 401: an exemplary water inlet.

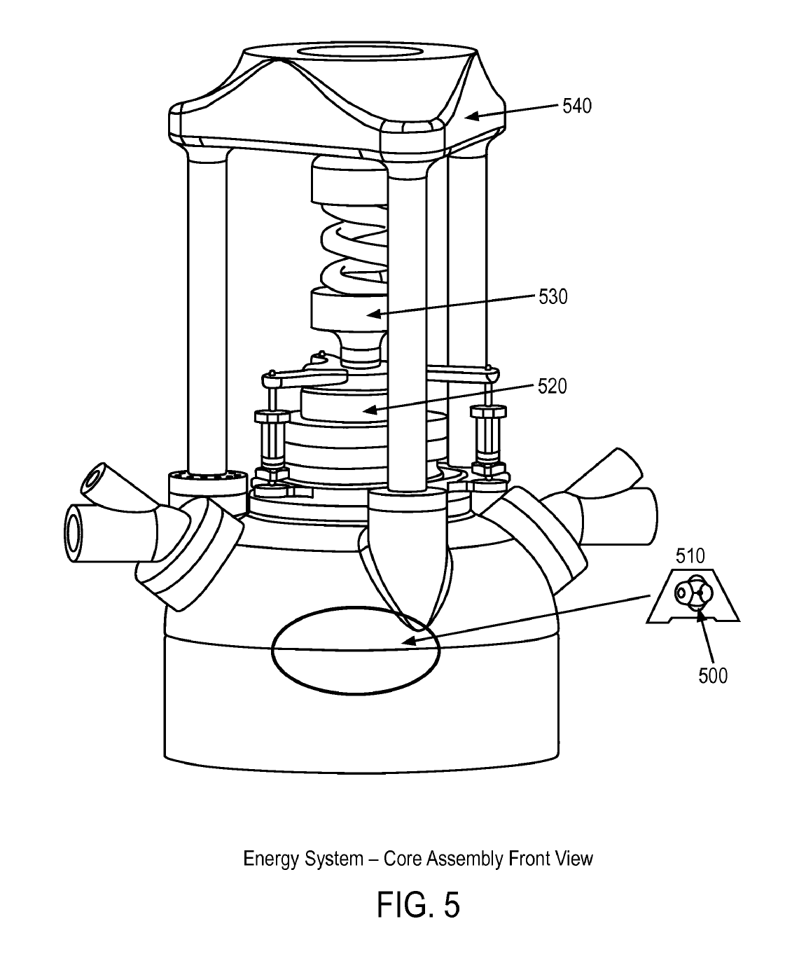

### FIG. 5 Elements:

element 500: a fuel pellet;
element 510: a fuel pellet cap;
element 520: a collar;
element 530: upper pile driver; and
element 540: a hydraulic compression system.

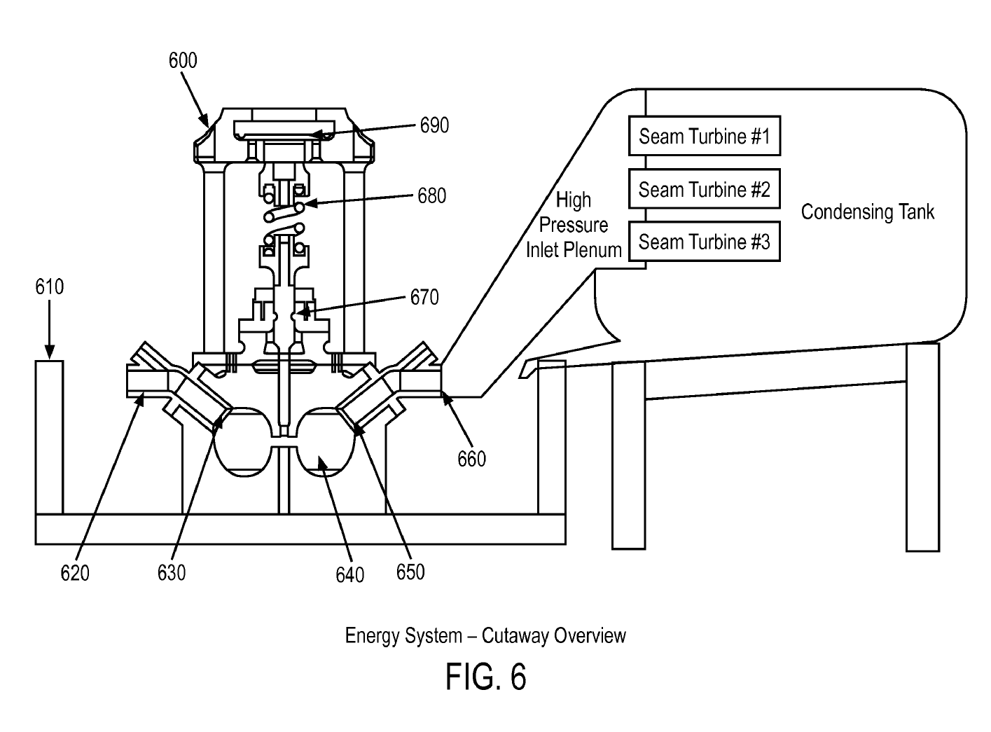

### FIG. 6 Elements:

element 600: an exemplary energy system core assembly;
element 610: a main water tank;
element 620: a intake port;
element 630: a intake valve;
element 640: a Toroid combustion chamber;
element 650: a exhaust valve;
element 660: a exhaust port;
element 670: a retainer capsules;
element 680: a compression spring; and
element 690: a hydraulic compression plate.

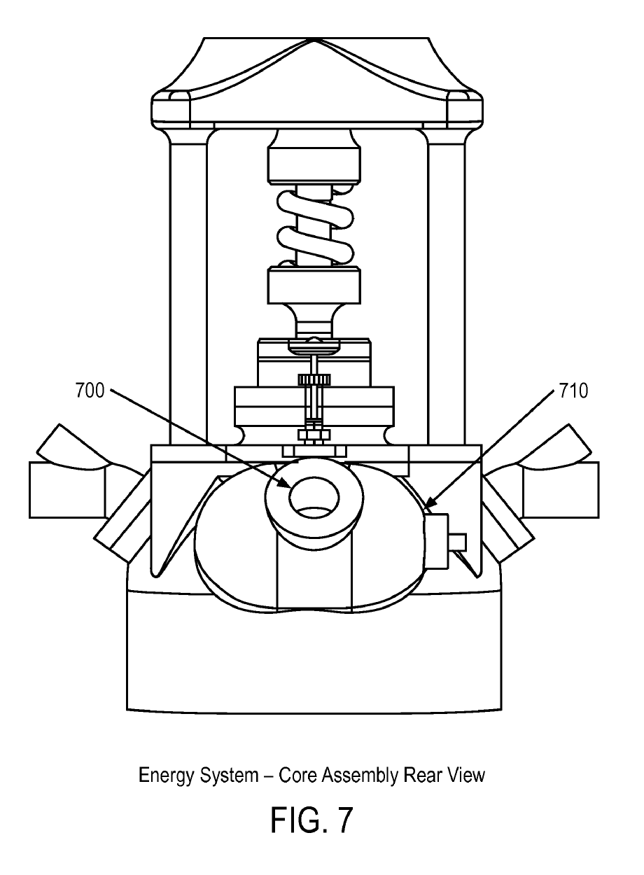

### FIG. 7 Elements:

element 700: a robot access door; and
element 710: a cylindrical tube.

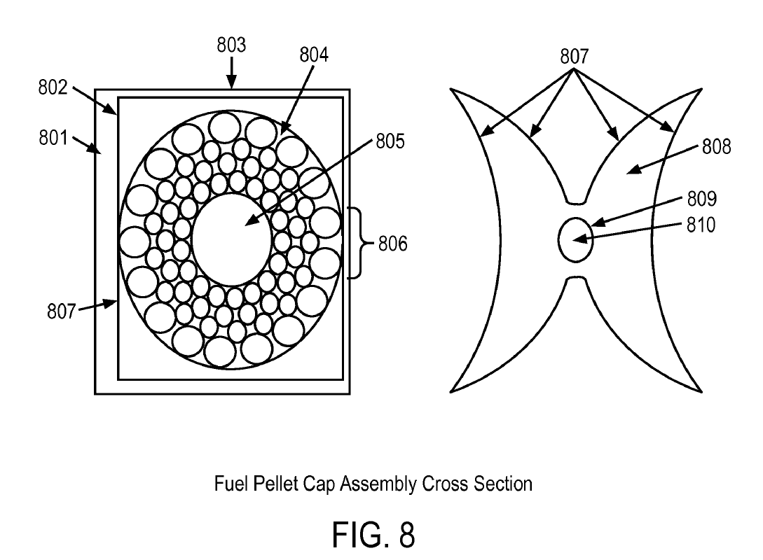

### FIG. 8 Elements:

element 801: an enclosure cube;
element 802: a top quasi-hemispherical cap;
element 803: a top where the pile driver makes contact;
element 804: spherical shaped balls for uniform compression;
element 805: a fuel pellet, in which the center thin-walled sphere contains the fuel;
element 806: a critical dimension to ensure uniform and total compression (negative in some cases);
element 807: a bottom quasi-hemispherical cap.
element 808: Solid or liquid (e.g., Tantalum);
element 809: Thick walled inner core (e.g., Tungsten); and
element 810: a center inner core.

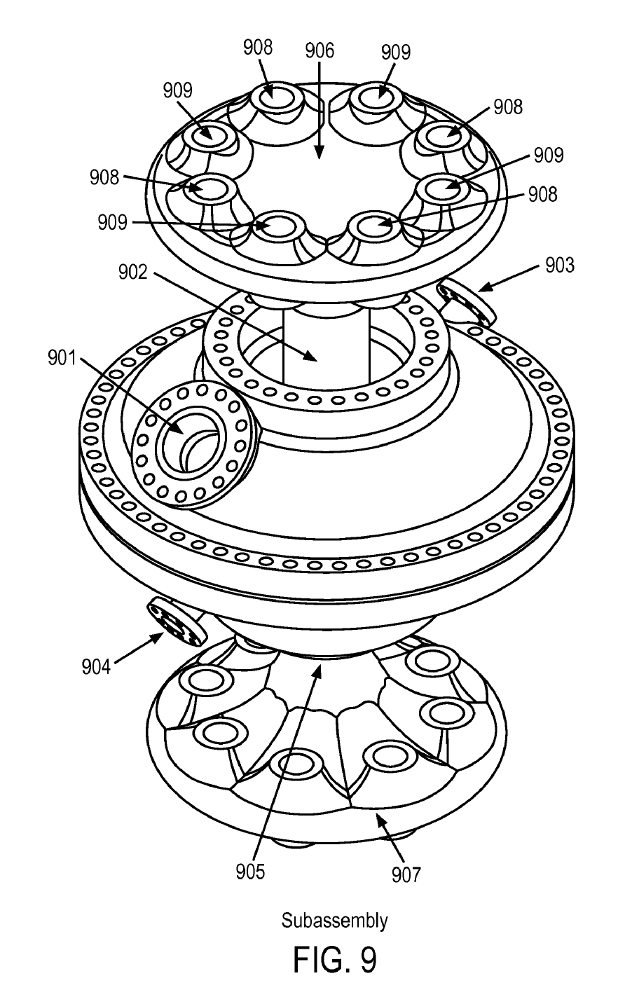

### FIG. 9 Elements:

element 901: robot door flange;
element 902: pile driver shaft;
element 903: steam exhaust;
element 904: water inlet;
element 905: lower pile driver/receiver shaft;
element 906: upper pile driver;
element 907: lower pile driver;
element 908: “push” hydraulic actuated cylinder mount; and
element 909: “pull” hydraulic actuated cylinder mount.

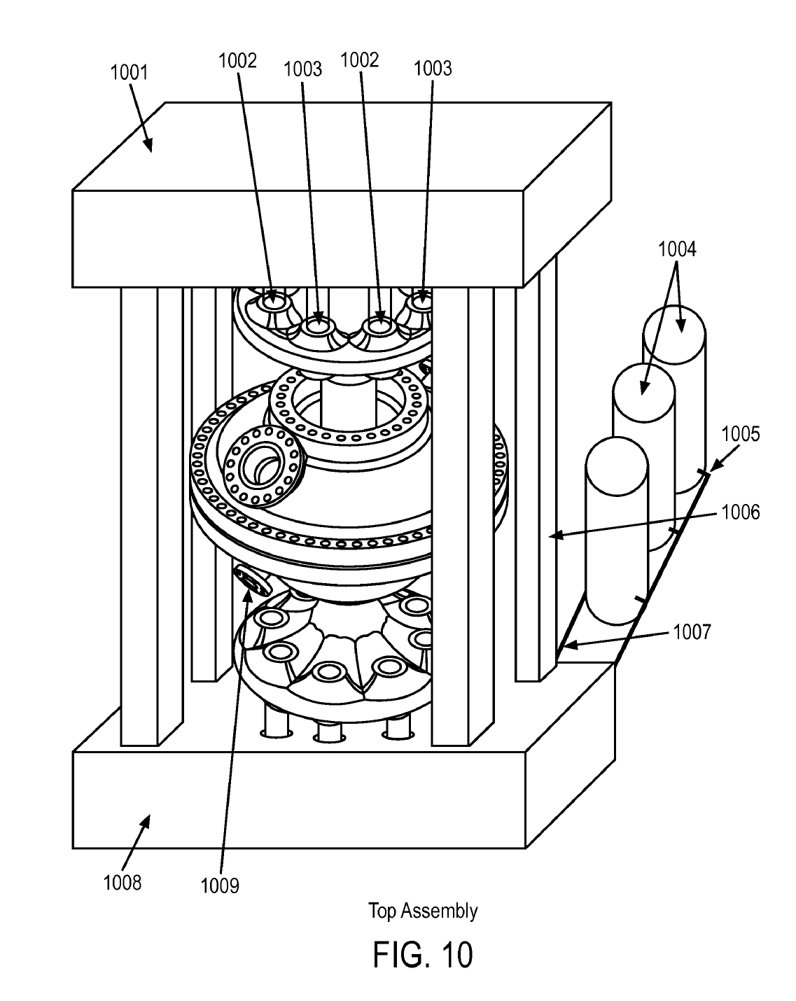

### FIG. 10 Elements:

element 1001: upper hydraulic actuator cavity;
element 1002: “push” hydraulic cylinders;
element 1003: “pull” hydraulic cylinders 1003;
element 1004: high pressure air/water containers;
element 1005: high pressure supply lines;
element 1006: stanchion;
element 1007: line;
element 1008: lower hydraulic actuator cavity; and
element 1009: water inlet.

Turning now to the figures, FIG. 1 depicts a fusion engine overview system, showing a fusion engine 101, blowdown vessel 102, and a high pressure regulator 103 along with representative balance of plant elements in accordance with which embodiments may operate.

### Fusion Fuels:

Fusion fuels for this fusion reactor can be composed of light atomic nuclei like hydrogen, deuterium, tritium, helium, lithium, beryllium, boron, and their various isotopes. Some isotopes other than deuterium and tritium like hydrogen-1, helium-3, lithium-6, lithium-7 and boron-11 are of interest for aneutronic nuclear fusion (low neutron radiation hazards), for example:

TABLE 1

| Reactants | Yields | Products | | MeV | | GWh/kg) |
|---|---|---|---|---|---|---|
| ¹H + 2 ⁶Li | → | ⁴He + (³He + ⁶Li) → | + | 20.9 | ≈ | 42 |
| | | 3 ⁴He + ¹H | | | | |
| ¹H + ⁷Li | → | 2 ⁴He | + | 17.2 | ≈ | 56 |
| ³He + ³He | → | ⁴He + 2 ¹H | + | 12.9 | ≈ | 57 |
| ¹H + ¹¹B | → | 3 ⁴He | + | 8.7 | ≈ | 18 |

Boron and helium-3 are special aneutronic fuels, because their primary reaction produces less than 0.1% of the total energy as high energy neutrons, requiring minimal radiation shielding. In several embodiments the kinetic energy from the fusion is directly convertible into electricity with a high efficiency, more than 95%.

Tritium is very rare costing nearly $1 million per ounce. Boron and many of the other fusible materials which are used in various embodiments of the instant invention are readily available, abundant and inexpensive.

FIG. 2 depicts a 3D view of an exemplary 16.0 ft diameter by 10.0 ft. high forged titanium or steel pressure vessel for over 2500 psi operation in accordance a disclosed embodiment.

High pressure steam outlet 203, and a water inlet 204, and a pile driver recoil spring cavity 205 (in some embodiments, the springs are replaced by compressed air and water/oil based hydraulic systems having hair-breadth controls) that absorbs some of the shock when the pile driver hits the recoil platform in the center of the Toroid on the lower half.

FIG. 3 depicts an exemplary cutaway view of pressure vessel showing half of a Toroid in accordance with which embodiments may operate. It contains a robot arm entry rotating door 301 and a pile driver entrance cavity 302, a high pressure steam outlet 303, a water inlet 304, and a pile driver recoil spring cavity 305 (in some embodiments, the springs are replaced by compressed air and water/oil based hydraulic systems having hair-breadth controls) that absorbs some of the shock when the pile driver hits the recoil platform in the center of the Toroid on the lower half and a large Toroid with the center cutout for containing the water and steam.

FIG. 4 depicts an exemplary cutaway view of lower half of pressure vessel showing a water inlet 401 in accordance with which embodiments may operate.

FIG. 5 depicts an exemplary energy system core assembly front view in accordance with disclosed embodiments. For the core part of one embodiment the energy system apparatus. The instant invention is a “pulsed” fusion energy system which does not require continuously maintaining extremely high temperature plasma. It uses a custom made large hydraulic press capable of delivering many thousands of tons of force, to fuse the fuel pellet 500, which is a small (in one embodiment ¼ inch diameter) sphere of tungsten, osmium, iridium or other suitable high density material filled with approximately 1 cubic-centimeter (“cc”) of fusible materials, (e.g., 1 cc of liquid hydrogen, deuterium, tritium, boron, lithium, etc.) inside the sphere.

The fuel pellet 500 is consumable and is fully encapsulated inside a fuel pellet cap 510 which is designed to fit on the center of the Toroid table. The robot picks the next fuel pellet cap 510 in sequence from a conveyor or tray and places it onto the Toroid bottom table which is constructed of material having extremely high compression strength that can withstand high temperatures. Note that the lower tip which forms the Toroid table top is replaceable as is the tip of the upper pile driver 530. These replaceable solid cylinder ends are also constructed of high compression strength material similar to large C-5, Boeing 747 or Tu-144 aircraft landing gear strut quality material strength.

The hydraulic press generates immense pressure as it pumps the compression spring downward from the top. A collar holds the retainer capsules 670 in place to restrain the pile driver 530 (in some embodiments, the large springs are replaced by compressed air and water/oil based hydraulic systems having hair-breadth controls). When it releases, it's similar in action to a spring loaded center punch or a large diesel pile driver 530. When it is released it is driven downward and super compresses the (approx. 1 cc) fusion capable material contained inside the thick sphere fuel pellet 500 of tungsten, osmium, iridium or other suitable high density materials.

It is held in place by a consumable fuel pellet cap 510 made of either tungsten, osmium, iridium, 7075 aluminum or other reasonable materials.

When the spherical shaped fuel pellet 500 is pulverized a fusion reaction occurs on the fusion capable materials inside (e.g., liquid hydrogen, lithium, or other fusion capable material).

In some embodiments, the spherical shaped fuel pellet 500 is encapsulated inside a thick tungsten sphere inside a larger cube of tantalum and the outer walls are tungsten as well which has a boiling point of 5555° C.

All materials on the Periodic Chart of the Elements up to Iron (Fe) are considered to be the best candidates for fusion capable materials, however, the farther one progresses up the periodic Chart there is generally diminishing returns of exothermic energy, so larger quantities and therefore larger fuel pellets are required to be embedded in the cap in order to make it more cost effective.

FIG. 5 further illustrates the pile driver 530 and the pile driver retainer collar 520 and the hydraulic compression system 540 and pile driver retention mechanism are implemented.

FIG. 6 depicts an exemplary energy system cutaway overview in accordance with disclosed embodiments. The fuel pellet cap 510 containing the tungsten or osmium/iridium sphere in the middle is pulverized and instantly compresses the fusion capable materials at a preset (very high) number of pounds of force. Approximately 12,000 tons of force in accordance with one embodiment. FIG. 6 further illustrates the point of contact where the pile driver cylinder is hitting the fusion material (in this embodiment, it's liquid Hydrogen, but it could be lithium, boron or any other fusible materials).

The fuel pellet cap 510 is a consumable item, so after a firing, it may be replaced with a new one. This is a small expense compared to the millions of watt-hours of electricity generated by the fusion reactions. A small robot or robotic arm like automobile manufacturers use replaces the consumable items and/or periodically removes the debris after the explosion occurs when the cylindrical shaped access door reopens (e.g., see FIG. 7).

One of the embodiments uses a device similar to an enormous spring loaded center punch, and a quasi spherical shaped combustion chamber with walls several inches to several feet thick made of steel, Inconel™, titanium, or other strong materials or combinations of materials.

In another embodiment, the springs are replaced by a compressed air/water hydraulics system, which precisely manipulates the “pile driver shuttle” to less than the width of a human hair. The retainer pins are unnecessary in this embodiment, so they are eliminated.

The combustion chamber in this embodiment is modeled similar to a regular internal combustion engine but it contains a water inlet 204 and an exhaust valve. And they perform very different functions.

The water inlet 204 is a nine [9] inch diameter tube that lets in water to fill the chamber prior to firing.

The exhaust valve lets out the steam to drive the steam turbines. In one embodiment, the exhaust valve is actually a pressure relief/exhaust valve that opens and begins releasing pressure at 2,000 psi.

The fusion is caused by brute force similar to a diesel pile driver but much more powerful. The driving cylinder doesn't need to travel very far, only a few feet.

The fuel pellet 500 consists of a small sphere of a very dense material such as tungsten, osmium, iridium, or other high density material that will contain the fusible materials (e.g., liquid hydrogen) for a few seconds, until it's imploded. The material must be high density to maximize containment. Osmium is 22.6 gm/cm3 and iridium is 22.42 gm/cm3 tungsten is much cheaper and it's 19.29 gm/cm3. This will minimize the tendency of the fusible material squirting out and it will keep the atoms and molecules tightly packed while they're being compressed to overcome the Coulombic electrical repulsion forces and weak nuclear forces to fuse together and emit the energy of fusion.

The fuel pellet 500 has a small one cc chamber in the center and it may be already pre-filled if the fusile material is near room temperature, it may also be filled with a hypodermic type device or it could have a small cone shaped plug (like a wine bottle cork) that is plugged in once the pellet is filled with a fusible material (e.g., liquid hydrogen).

The optional main water tank 610 around the main core is much larger than the base of the unit and the unit may be immersed in water up to the middle of the Toroid chamber or even higher.

FIG. 7 depicts an exemplary energy system core assembly rear view showing a robot access door in accordance with disclosed embodiments. FIG. 7 further depicts a cutaway view of the tungsten backing plate.

The cylindrical tube 710 containing the robot access door 700 opens between firings to provide entry for the robot to cleanup and replace consumable parts and/or materials in preparation for the next firing. The cylindrical tube 710 is mounted on the robot door flange 901

The fuel pellet 500 is prefabricated and immersed inside two quasi-hemispherical caps of tungsten, titanium or Inconel™ in one set of embodiments. The fuel pellet 500 and cap assembly may be coated with aluminum in one embodiment, and then it becomes the fuel pellet cap 510 assembly.

In one embodiment, the robot picks the next prefabricated, pre-filled fuel pellet cap 510 and places it inside the combustion chamber atop the pedestal in the center, directly below the pile driver cylinder. In another embodiment, the robot picks the next fuel pellet cap 510 sequentially from a conveyor or tray, then dispenses approximately 1 cc of liquid hydrogen into the pellet and places the plug in the hole and places the entire cap assembly inside the combustion chamber atop the pedestal in the center, directly below the pile driver cylinder.

While the robot is busy loading the next fuel pellet cap 510 assembly, the pile driver 530 is being pumped up by compressing the spring using hydraulics, from above, while it is held in the detent position by three 9 inch diameter 18 inch long capsules that are retained by the pile driver collar 520. These three spring capsules pop out when the collar is lifted. In another embodiment, the springs are replaced by a compressed air/water hydraulics system, and while the robot is busy loading the next fuel pellet cap 510 assembly, the pile driver 530 is being positioned by the hydraulic, compressed air system the pile driver collar 520. The compressed air/water hydraulic system is precise to less than the width of a human hair. The retainer pins are unnecessary, so they are eliminated.

Also, while the robot is busy loading the next fuel pellet cap 510 assembly, the intake valve 620 is open and the chamber is filling with water. In one embodiment, a high pressure pump is used to fill the chamber, in order to fill the several thousand gallon chamber in just a few seconds to prepare for the next pop.

When the robot is done loading the cap, and the chamber is filled up near the bottom of the exhaust valve 650, the pile driver shaft is released with around 12,000 tons of force.

If 12,000 tons of force are applied to a cube 2 cm on a side, the pressure is on the fuel pellet cap assembly would be 77.42 million psi.

When the pile driver 530 cylinder strikes the fuel pellet cap 510, the spherical shaped fuel pellet 500 is crushed and the fusible fuel inside undergoes fusion and releases a large amount of energy. In one embodiment using deuterium/tritium, requires approximately 10 KeV per molecule input energy to compress deuterium and tritium material in close enough to fuse into helium. Then the exothermic energy released is 17.6 MeV per molecule. The output energy then is roughly 1,760 times the input energy for each molecule produced. With 100% yield, that would be 1,760 to 1, but experience shows that the yield is less than 100%. Some of the atoms escape into the high density containment material. It's reasonable to expect around 60% yield.

The fiery blast of the fusion would normally be quite large. But, it's absorbed and dampened by immersing the blast area in a pool of water inside the combustion chamber. The pool of water is instantly superheated into high pressure steam and the high pressure relief/Exhaust valve opens at 2,000 psi of pressure in one embodiment.

There may be a large pool of water around the combustion chamber enclosing the outside and forms a water jacket around the combustion chamber. This larger pool of water may also be used to fill the combustion chamber for each pop since the water level remains slightly above the intake port 620. Also, when the steam condenses after a pop the residual water is channeled back into this larger pool via the condensing tank drain spout.

The water is continually recycled, and after some time, there are evaporation losses, so that periodically, some water must be added back into the system. Also, residue from the blasts may build up over weeks and months, such that it must periodically be removed with a combustion chamber cleaning cycle, achieved with a robotic arm much like the multi-axis robotic arms used in the automotive industry.

The steam contains the heat from the fusion while it is being routed through the exhaust valve and consumed by the steam turbine generators. This fusion combustion chamber is much like a cylinder in a top fuel dragster engine. It is an explosion-proof chamber capable of handling many atmospheres of pressure, although in several embodiments, the pressure relief/exhaust valve is preset to open at 2,000 psi.

The valve is controlled to meter the pressure into the steam turbine's intake plenum chamber so as not to overload the turbines.

Once the steam passes through the turbines, it collects in the condensing tank and becomes water, then either flows by gravity or is pumped back into the holding tank.

The holding tank also acts as a water jacket to insulate the combustion chamber apparatus.

One embodiment uses deuterium and tritium as the fusible materials. The estimated yield of this process would be about 1,760 to 1 if the fusible materials are totally consumed, although experience shows that we would normally expect about 60 percent of the reactants to fuse. These numbers vary greatly using other fusible materials which range from hydrogen up to iron (Fe) on the Periodic Chart of Elements.

Following are some example calculations. These calculations have not yet been peer reviewed for accuracy.

### Density and Yield (Using Deuterium and Tritium as a Baseline):

Consider the following from tables 2, 3, and 4 as follows:

TABLE 2
₁¹H₂ is 2 gm per mole & LH2 density is .071 gm/cm³ therefore: 1 cm^{3 =} 0.0352 mol
₁²H + ₁³H -> n + ₂⁴He + 17.6 MeV And 1 J = 2.78E−07 KWhr And 1 MeV = 4.45E−20 KWhr
Input Energy for 100% reaction:

| | mol | Atoms/mol | MeV/atom | KWhr/MeV | KWhr |
|---|---|---|---|---|---|
| 1 cc =>: | 0.0352 * | 6.02E+23 * | .01 * | 4.45E−20 = | 9.43 i.e. 3.40E+07 = 34 MJ |

TABLE 3
Output Energy for 100% reaction:

| | mol | Atoms/mol | MeV/atom | KWhr/MeV | KWhr |
|---|---|---|---|---|---|
| 1 cc >: | 0.0352 | 6.02E+23 | 17.6 * | 4.45E−20 | = 1.66E+04 |

TABLE 4
Water Required:
A 50,000 KW (50 MW) Steam Turbine uses 569,000 lb of steam per hour
This is 11.38 lb/KWhr And water weighs 8.34 lb/gal

| | |
|---|---|
| 1 cc | 16,600 KWhr * 11.38 lb/KWhr/8.34 lb/gal = 21,832 gal of |
| requires: | H₂O |
| | In a 50 MW Turbine this is about 1/3 of an hour at capacity, |
| | so pop every 20 minutes for full 50 MW capacity |
| | Now: Assuming only 60% reaction: |
| .6 cc | 10,000 KWhr * 11.38 lb/KWhr/8.34 lb/gal = 13645 gal of |
| | H₂O |
| | In a 50 MW Turbine this is about 1/5 of an hour at capacity, |
| | So pop every 12 minutes for full 50 MW capacity. |

Some energy is spent vaporizing the water 1 cal=1 gm*1 degree C. and 1 J=4.186 cal.

1 Mole of H2O gas normally occupies 22.4 liters @ STP, but it's gaseous at 100 C=373K and PV=nRT. At these high pressures that 22.4 l/mol is dramatically compressed.

TABLE 5
Combustion Chamber Sizing: (for 60% reaction)
109,248 lb/2.205 lb/1 = 49,5461 * 1 m³/1,000 liters = 49.55 m³
r = 2.28m = 7.48 ft For 60% yield of 1 cc
It doesn't fill all the way to the top and the pedestal displaces some
water, and thus, a 16 ft to 17 ft diameter sphere Toroid do for 60%
yield of 1 cc of said fusible material. In one embodiment, 6 m diameter
is used to provide a good safety margin.

TABLE 6
Heat to convert Water to Steam (assuming 109,248 lbs of water per pop):
109,248 lb * 453.59 gm/lb * 100° C. = 5.02E09 cal * 4.187 J/cal *
2.78E−07 KWhr/J = 5,844 KWhr
So the remainder of the energy goes into superheating and pressurizing
the steam

Ideally all embodiments would use Osmium, the densest element for containment. The density of osmium is 22,610 kg/m³ (22.61 g/cm³), slightly greater than the density of iridium, the second densest element. Unfortunately, Osmium and Iridium are very rare and expensive. Less expensive elements that are almost as dense are Tungsten and Tantalum (see Table 7).

In the overview set forth at FIG. 5, having the Energy System, as well as implementing methods and apparatuses; one fusion cycle includes intake, power and exhaust.

During the intake cycle the robot loads a fuel pellet cap 510 while the water is filling through the 9 inch water inlet 304 and if the previous explosion didn't force the spring loaded pile driver all the way to the detent position, it is further retracted upward by the hydraulics subsystem apparatus until it reaches the detent position. Then it is compressed downward to load for the next firing. In some embodiments the hydraulic compressed/air water system is so precise that springs and detent pins are not required.

During the power cycle the pile driver 530 is released and it fuses the fuel inside the fuel pellet cap 500 which vaporizes the water into high pressure super heated steam. Once the pile driver 530 piston makes contact, it's dwell time is very brief only to achieve Lawson's criterion (roughly 5 microseconds, then it experiences a quasi-elastic collision after which it subtends approximately 0.1 steradians of solid arc and the explosions propels it upward to the detent position, much like the manner in which a diesel pile driver works. The hydraulics automatically engage to ensure that the motion is regulated not to overshoot or undershoot the detent position, to preload for the next firing. The hydraulic compressed air/water system is very accurate and positions the pile driver within thousands of an inch without the need for springs.

During the exhaust cycle, the pressure relief valve/ exhaust valve 650 opens at 2,000 psi in this embodiment and releases enough steam to drive the steam turbines optimally. The blow-down tank 102 and the high pressure regulator 103 meters the steam to avoid overloading the steam turbines. The valve opening is controlled dependent on closed loop feedback control of exhaust pressure using pressure sensors mounted in the plenum. When the pile driver 530 strikes the fuel pellet cap 510 it recoils from the collision and the subsequent explosion which compresses the pile driver 530 spring to preload it for the next cycle. The hydraulics are pre-charged and engage to provide a little more push in case it's required.

These cycles are repeated as needed each time the steam energy is used or dissipates to a low level, generally ten to thirty minute intervals dependent on demand, but it's possible to pop every 2 minutes if necessary to support demand. Note: in this embodiment, each pop yields 16.6 MWhr and one pop every 20 minutes yields 50 MWhr at 100 percent using 1 cc of fusile material for each pop, then one pop every two minutes would yield 500 MWhr. And one pop per minute would yield 1,000 MWhr. And 1,000 MW steam generators are available off-the-shelf to for completing the “Balance of Plant” (BoP).

The various steps are described in detail on the figure. There are heavy duty compression rings around the cylinder to form a labyrinth seal. The large cylinder is a sort of projectile, being accelerated downward with tremendous forces. The diameter of the projectile for this embodiment is 18 in. to 24 in.

FIG. 8 depicts two views of fuel pellet cap assemblies in accordance with disclosed embodiments. Specifically, fuel pellet cap assembly detailed cross sections or a cutaway view are depicted, revealing the detailed components.

In one embodiment the entire fuel pellet cap assembly is packaged in an enclosure cube 801 of a metal such as T-6 aluminum or 7075 aluminum. The top quasi-hemispherical cap 802 encapsulates the upper portion of the fuel pellet. In some embodiments the top is flat and in others, the top is an actual hemisphere with curved outer walls. The top 803 is where the pile driver makes initial contact to begin compressing the top quasi-hemispherical cap 802 and the spherical shaped balls 804 around the fuel pellet 805. In one embodiment these spherical shaped balls 804 are high density tungsten to provide uniform compression of the fuel pellet. These spherical shaped balls 804 may be all the same size or varying sizes as one progresses out from fuel pellet 805 in the center. The thin-walled sphere in the center containing the fuel is the fuel pellet 805. The critical dimension 806 is to ensure uniform and total compression. This is negative in many cases. (e.g., the top quasi-hemispherical cap is slightly smaller than the bottom quasi-hemispherical cap 807 and the outside of the top quasi-hemispherical cap is a rounded thin-walled hemisphere, rather than cube shaped, so that it fits inside the curvature of the bottom quasi-hemispherical cap 807 as the fuel pellet cap assembly FIG. 8 is compressed.

In some embodiments the spherical shaped balls 804 are replaced with mercury (Hg) or other high density liquid to maintain maximum compression on the fuel pellet 805 in the center.

In some embodiments the fuel pellet cap assembly is packaged in a cube or hemisphere. In alternative embodiments the fuel pellet cap assembly is packaged in an enclosure shaped like a modified toroid 807 with the outside edges concaved inward vertically and in which the inside edges of the toroid are normal convex outward so that, as the assembly is crushed, the pressure builds fairly uniformly around the sphere in the center 809. These embodiments are constructed of Tungsten 807 on the outside crust and filled with Tantalum 808. The Tantalum 808 may be solid or liquid. In some embodiments the entire assemblies are kept in a preheated kiln just above 3,000 degrees C. At that temperature, the Tantalum 808 is liquid, while the Tungsten outer shell 807 is still solid. The Tungsten thick walled inner core 809 is solid, while the fusionable materials inside have boiled and become a high temperature, high pressure gas. Some of the elements properties are listed in table 7. Note that all of these boil and become gaseous below 3,000 degrees Celsius.

TABLE 7

| Element | Density gm/cm³ | Melting Point ° C. | Boiling Point |
|---|---|---|---|
| Ta | 16.6 | 2996 | 5425 |
| W | 19.29 | 3410 | 5660 |
| Os | 22.60 | 3045 | 5027 |

TABLE 8

| Element | Density gm/cm³ | Melting Point ° C. | Boiling Point |
|---|---|---|---|
| H | .071 | −259 | −252 |
| He | .126 | −272 | −268 |
| Li | .530 | 180.5 | 1342 |
| Be | 1.85 | 1278 | 2970 |
| B | 2.34 | 2300 | 2550 |

FIG. 9 depicts a sub-assembly containing the Pressure Chamber, upper hydraulic actuated pile driver and lower hydraulic actuated pile driver/receiver in accordance with disclosed embodiments. The rotating cylindrical robot door 710 bolts onto the robot door flange 901. The pile driver shaft 902 is the main pile driver that crushes the fuel pellets in FIG. 8. A pressure relief valve circa 2,500 psi bolts onto the steam exhaust 903.

An inlet valve is bolted to the water inlet 904 and a standard pump capable of delivering several thousand gallons per minute is bolted to the water inlet valve.

The upper pile driver 906 and the lower pile driver 907 are identical. The lower pile driver/receiver shaft 905 may be positioned totally independently of the upper pile driver. They are coordinated via software and hydraulic controls to quickly immerse and implode the fuel pellets, immediately after being placed by the robotic arm and the robotic arm door is closed which is typically milliseconds. The lower pile driver/receiver drops and immerses the fuel pellet cap and stops rigidly just an instant before the accelerating upper pile driver begins crushing the pellet from the top. Both upper and lower pile drivers are immediately retracted. They need to maintain pressure and confinement only long enough to meet Lawson's criterion. The ends of the pile drivers are covered with high temperature metal alloy covers which are consumable and may be replaced by the robotic arm.

The upper pile driver 906 and the lower pile driver 907 each contain 8 hydraulic cylinder insert cavities. There are four “push” 908 and four “pull” 909 hydraulic actuated cylinder mounts on each pile driver.

FIG. 10 depicts a top assembly incorporating the sub-assembly of FIG. 9 and excluding the standard off-the-shelf water pump, blow down pressure vessel and high pressure regulator in accordance with the disclosed embodiments.

The upper hydraulic actuator cavity 1001 and the lower hydraulic actuator cavity 1008 are essentially identical. They may contain the Hydraulic pumps as well, or these may be placed beside the main unit. The “push” hydraulic cylinders 1002 are fitted into the push cavity mounts 908 and the “pull” hydraulic cylinders 1003 are fitted into the pull cavity mounts 909. Similarly on the lower side, there are push and pull cylinders. The high pressure air/water containers 1004, maintain the supply for instantaneous actuation and control of the push/pull hydraulics. The high pressure supply lines 1005 are routed into the lower hydraulic actuator cavity 1008 to the lower hydraulic actuators and up the stanchions 1006 to the upper hydraulic actuator cavity 1001. The lines from the pumps 1006 are routed from the standard hydraulic pumps behind the unit. These pumps may also be mounted in the upper and lower hydraulic actuator cavities 1001,1008.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method comprising:
inducing mechanical fusion to generate heat energy; and
generating high pressure steam from the heat energy.

2. The method of claim 1, wherein inducing mechanical fusion comprises:
compressing a spherical fuel pellet assembly substantially uniformly to crush a center portion of the spherical fuel pellet assembly.

3. The method of claim 2, wherein the spherical fuel pellet assembly comprises high density liquid to crush the center portion uniformly when compressed.

4. The method of claim 2, wherein compressing the spherical fuel pellet assembly substantially uniformly comprises compressing, via two overlapping quasi-hemispheres that compress the spherical fuel pellet assembly in the center of the two overlapping quasi-hemispheres fairly uniformly.

5. The method of claim 4, wherein a pile driver compresses the two overlapping quasi-hemispheres together.

6. The method of claim 5, wherein the pile driver comprises a hydraulic press to drive the two overlapping quasi-hemispheres together.

7. A mechanical compression chamber to generate high pressure steam from a mechanically induced fusion reaction.

8. The mechanical compression chamber of claim 7, wherein the mechanically induced fusion reaction comprises crushing a fusion fuel pellet assembly having spheres therein to crush a center portion fairly uniformly when compressed by the mechanical compression chamber.

9. The mechanical compression chamber of claim 7, wherein the mechanically induced fusion reaction comprises crushing a fusion fuel pellet assembly having high density liquid therein to crush a center portion fairly uniformly when compressed by the mechanical compression chamber.

10. The mechanical compression chamber of claim 7, wherein two overlapping quasi-hemispheres form the mechanical compression chamber.

11. The mechanical compression chamber of claim 10, wherein a pile driver compresses the two overlapping quasi-hemispheres together.

12. The mechanical compression chamber of claim 11, wherein the pile driver comprises a hydraulic press to drive the two overlapping quasi-hemispheres together.

13. An energy system comprising:
a mechanical compression chamber;
a spherical fuel pellet assembly substantially to uniformly crush a center portion of the spherical fuel pellet assembly when compressed within the mechanical compression chamber; and
a compressing force means to compress the spherical fuel pellet assembly within the mechanical compression chamber, wherein the spherical fuel pellet assembly to release heat energy from mechanically induced fusion when compressed within the mechanical compression chamber.

14. The energy system of claim 13, wherein the compressing force means comprises a hydraulic press to drive two overlapping quasi-hemispheres of the mechanical compression chamber together.

15. The energy system of claim 13, wherein high pressure steam is generated from heat energy within the mechanical compression chamber from the spherical fuel pellet assembly being compressed.

16. The energy system of claim 13, further comprising means to convert heat energy from the mechanically induced fusion to electrical energy.

17. The energy system of claim 13, wherein the spherical fuel pellet assembly comprises a high density liquid to crush the center portion of the spherical fuel pellet assembly fairly uniformly when compressed by the mechanical compression chamber.

18. The energy system of claim 13, wherein the spherical fuel pellet assembly comprises a plurality of spheres therein to crush a center portion of the spherical fuel pellet assembly fairly uniformly when compressed by the mechanical compression chamber.

19. A method for generating high pressure steam using mechanical fusion.

20. An apparatus comprising:
means for generating high pressure steam using mechanical fusion.

21. A fusion fuel pellet assembly having interior spheres to crush a center fairly uniformly when compressed.

22. A fusion fuel pellet assembly having high density liquid therein to crush a center fairly uniformly when compressed.

23. A method of inducing mechanical fusion comprising:
compressing fairly uniformly, a fusion fuel pellet assembly having high density liquid therein, the high density liquid to crush a center of the fusion fuel pellet assembly fairly uniformly when compressed;

24. The method of claim 23, wherein the center comprises fusionable materials.

25. A method comprising:
compressing a fusion fuel pellet assembly between two overlapping quasi-hemispheres that compress a fuel pellet interior to the fusion fuel pellet assembly in a fairly uniform manner.
